(19) United States
(12) Patent Application Publication
(10) Pub. No.: US 2012/0136839 A1
(43) Pub. Date: May 31, 2012

(54) User-Driven Conflict Resolution Of Concurrent Updates In Snapshot Isolation

(76) Inventors: Peter Eberlein, Malsch (DE); Markus Schmidt-Karaca, Heidelberg (DE)

(21) Appl. No.: 12/957,356

(22) Filed: Nov. 30, 2010

(51) Int. Cl. G06F 17/30

(52) U.S. Cl. 707/690; 707/E17.005

(57) ABSTRACT

Devices, methods and systems for reconciling data conflicts between concurrent updates made in snapshot isolation are disclosed. Conflict resolution between first and second user transactions may be performed by determining that at least a portion of second user data is in conflict with at least a portion of the first user data, identifying the specific data from each of the first and second user data that is in conflict, displaying the specific data in conflict on a user interface of the second user and allowing the second user to resolve the conflict by choosing which of the specific data in conflict is correct. Upon the second user choosing which data is correct, the user interface and the database may be updated to reflect this selection. Related systems, methods, and articles of manufacture are also described.

### FIELD

The subject matter described herein relates to user-driven reconciliation of data conflicts that arise between concurrent updates made in databases with snapshot isolation.

### BACKGROUND

A database consists of an organized collection of data for one or more uses, typically in digital form. Digital databases are managed using database management systems (DBMSs). A DBMS consists of software that operates and controls the creation, maintenance and use of a database, including providing storage, access, security, backup and other support capabilities. DBMSs may be categorized according to the database model they support (e.g., relational, network, hierarchical or object), the type(s) of computers they support (e.g., a server cluster or mobile phone), the database query language(s) used to access the database (e.g., SQL or XQuery), and performance trade-offs (e.g., maximum scale or maximum speed).

An aspect of some DBMSs is providing transaction mechanisms that allow users to store, retrieve and/or update information relating to a specific data item contained within a database in a structured way, e.g., extract information from the database using a read operation or update a particular data item with new information using a write operation. Instead of writing computer programs to extract information from a database, a DBMS allows a user to ask a question or insert new information in simplified query language.

Many DBMSs also allow different application programs to access the same database. To ensure data integrity and consistency during these operations, DBMSs typically adhere to the ACID rules: Atomicity (all data changes in a single transaction must commit), Consistency (every transaction must preserve the declared consistency rules for that database), Isolation (two concurrent transactions cannot interfere with one another), and Durability (completed transactions cannot be later aborted or discarded). In practice, many DBMSs allow the selective relaxation of these rules to balance perfect behavior with optimum performance.

More often than not, a single database and/or data item within that database will be accessed by multiple users at the same time. That is, two or more concurrent operations, queries, or transactions may be requested for the same data item in the same database. DBMSs employ concurrency controls to ensure that database transactions on the same data item will be performed at the same time without the concurrency violating the data integrity of that database. Concurrency controls isolate each transaction from the other to eliminate interference. A concurrency control method commonly used by DBMSs to provide concurrent access to a database is multi-version concurrency control (MVCC). MVCC provides each user connected to the same database with his or her own “snapshot” of the database to work with. MVCC ensures a transaction never has to wait for a specific data item by maintaining multiple versions of that data item. And any changes made to the database will not be seen by other concurrent users of that database until the transaction has been committed.

How and when changes made to a particular data item by one user transaction (e.g., a write operation updating the data item with new information) become visible to other concurrent transactions (e.g., a read operation for extracting information about the same data item) is defined in terms of “isolation.” Concurrent transactions may be isolated from one another to varying degrees. The highest degree of isolation is called serializability, where all transactions are processed in complete isolation, as if they were executed serially one after the other. Under this methodology, a DBMS may execute two or more transactions at the same time only if the illusion of serial execution is maintained. But maintaining this serializability and its associated high level of isolation typically requires locks on data, i.e., when a data item is being read or written to, no one else may concurrently read or write to it, resulting in a loss of concurrency and causing one or more user transactions to fail.

A lesser degree of isolation often employed by DBMSs is “snapshot isolation.” Snapshot isolation takes a snapshot of the database at the start of a transaction and the user's “view” of the database remains consistent with this snapshot during the entire transaction, even if another user concurrently working on one or more of the same data items writes to and changes those data items. Unlike serializability, snapshot isolation maintains concurrency and thus does not lock data items. Snapshot isolation guarantees that all read operations made in a transaction will see a consistent snapshot of the database and will allow a transaction to successfully commit only if no updates made by that transaction conflict with any other updates made concurrently by another user since the transaction started.

Modern databases and DBMSs often employ MVCC to provide consistent reads relative to the starting point of a transaction and concurrent updates using snapshot isolation methodology. An inherent trade-off of increasing parallelism (through snapshot isolation) that comes along with the renunciation of locking is that conflicting updates or other write operations may occur that will be detected and must be resolved. That is, when there is no lock on a particular data item and multiple users are allowed to concurrently access and operate upon that data item without knowledge of other users' operations, conflicts may arise if one user writes an update to the data item that is inconsistent with another user's operation for that data item. Such conflicts typically arise between operations of different transactions upon the same data item when at least one of them is a write operation, e.g., a read-write conflict, a write-read conflict or a write-write conflict. In any of these situations, the transaction of a second operation may be in conflict with a transaction of the first operation.

Conventional mechanisms for reconciling these data conflicts have been incorporated as part of the application logic and handled by the application itself programmatically. This methodology requires programmers to write application-specific coding, which is inefficient, time-consuming, and costly and which places an additional burden on an application's overall performance. As more and more business applications leverage such databases, conflict resolution places a burden on the performance of business applications.

### SUMMARY

In some of the implementations described herein, a computer program product may be tangibly embodied in a non-transitory machine-readable medium and contain instructions to cause a data processing apparatus to perform operations that include determining a conflict among at least one of a plurality of data items accessed in snapshot isolation by a plurality of users, generating, based on the conflict, a page including the at least one of a plurality of data items and providing to a user interface the generated page to enable resolution of the conflict.

In some related implementations of the present disclosure, a computer-implemented method may include determining a conflict among at least one of a plurality of data items accessed in snapshot isolation by a plurality of users, generating, based on the conflict, a page including the at least one of a plurality of data items and providing to a user interface the generated page to enable resolution of the conflict.

Some implementations may be directed to a system having a processor and a memory configured to perform a method that includes processing a first user request to update at least one of a plurality of data items in a database with first user additional data and updating at least one of the at least one of a plurality of data items with the first user additional data in response to the first user request. Implementations may further include processing a second user request to update at least one of the at least one of a plurality of data items in the database with second user additional data, determining that at least a portion of the second user additional data is in conflict with at least a portion of the first user additional data and identifying specific data from each of the second user additional data and first user additional data that is in conflict. In some implementations, a page may be generated including the specific data identified as being in conflict to enable resolution of the conflict at a user interface by choosing which of the specific data in conflict from the first user additional data and the second user additional data.

It should be noted that, while the descriptions of specific implementations of the current subject matter may discuss delivery of enterprise resource planning software one or more organizations, in some implementations via a multi-tenant system, the current subject matter is applicable to other types of software and data services access as well. The scope of the subject matter claimed below therefore should not be limited except by the actual language of the claims.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a system that includes two users accessing and operating upon a database, according to some implementations of the present disclosure.

FIG. 2 is a block diagram illustrating an example implementation of a resolution renderer, according to some implementations of the present disclosure.

FIG. 3 illustrates a screen shot of a user interface showing the visualization of a conflict resolution with accept and reject buttons for concurrently updated data, according to some implementations of the present disclosure.

FIG. 4 illustrates a process for user-driven conflict resolution, according to some implementations of the present disclosure.

FIG. 5 illustrates another process for user-driven conflict resolution, according to some implementations of the present disclosure.

Like reference symbols in the various drawings indicate like elements.

### DETAILED DESCRIPTION

The subject matter described herein relates to devices, systems, and methods for user-driven reconciliation of data conflicts that arise between concurrent updates made in databases with snapshot isolation. In particular, embodiments of the devices, systems, and methods described in this disclosure may eliminate the programming burden of developing application-specific conflict resolution coding within numerous pages of an application by instead providing a database, or an associated system (e.g., a DBMS) with a generic resolution renderer component. According to some embodiments, the generic resolution renderer component may be employed to denote conflicts in data arising between two or more concurrent transactions for the same data item taking place in snapshot isolation. When a conflict is denoted, the embodiments described herein may be configured to provide for identification and display of the conflicted data to the user interfaces of users whose transactions failed to commit because of the conflict. Such users, according to some embodiments, may then reconcile a denoted conflict and cause his or her transaction to successfully commit. Although not limited to specific database types or isolation methodologies, the embodiments of the present disclosure are particularly useful to resolve conflicts in cases where concurrent updates are performed on data that is not locked but isolated in snapshot isolation.

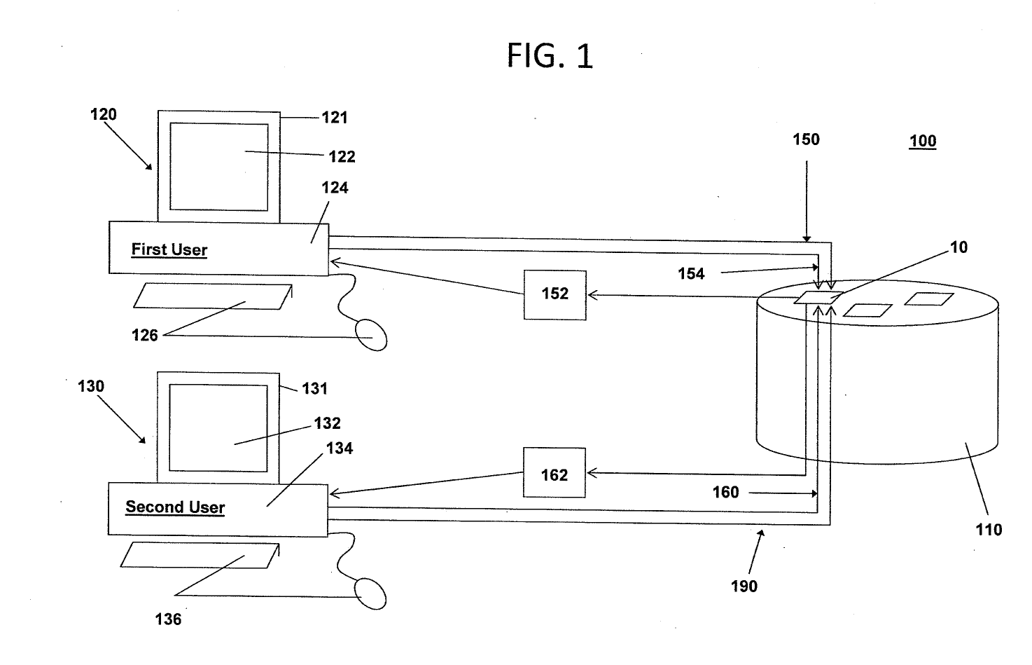

FIG. 1 shows a system 100 that includes a database 110 accessible by at least a first user 120 and a second user 130. The first user 120 may interface with the database 110 using a first-user machine 124 (e.g., a processor, a computer, and the like). The first-user machine 124 may be connected to a display 121 and one or more input devices 126 (e.g., a keyboard, a mouse, and the like). The machine 124 may be connected to the database 110 via a communication mechanism (e.g., a network, the Internet, and the like). Similarly, the second user 130 may also interface with the database 110 using a second-user machine 134. The second-user machine 134 may be connected to a display 131 and one or more input devices 136. The second-user machine 134 may be connected to the database 110 via a communication mechanism.

The first-user machine 124 and the second-user machine 134 may each include user interfaces, such as user interfaces 122 and 132. User interfaces 122 and 132 may be implemented as any type of interface mechanism for a user, such as a web browser (which may include one or more plug-ins), a client application, a thin client, and any other interface mechanism.

With reference to FIG. 1, an exemplary standard business transaction in snapshot isolation according to some embodiments will now be described. A first-user transaction 150 requesting to update a data item 10 in database 110 may commence at a time t₀. At the start of the first-user transaction 150, a snapshot of the database 110 as it exists at that time t₀ is provided at first-user interface 122. In some embodiments, the database 110 may reside on the first-user machine 124 and/or may be located remotely in which case the database 110 is accessed through any suitable communication mechanism. Also, while the illustrative transaction only involves an operation upon one data item, multiple data items in database 110 may be operated upon.

Upon entering a query (e.g., a write operation) to update information associated with data item 10, data item 10 may be retrieved from database 110 and read into an internal buffer 152. This buffer 152 may be used to temporarily hold data item 10 while a data model is built for a page corresponding to data item 10 to be presented at the first-user interface 122. The page may be implemented as any type of electronic document including for example a hypertext markup language (HTML) page. In some embodiments, system 100 may call a first-user application when the first-user transaction 150 is initiated to retrieve and/or read data item 10 into internal buffer 152 and build the data model for data item 10. Although FIG. 1 shows the buffer 152 separate from machine 124, the buffer 152 may be located anywhere suitable. A first-user interface generator may then bind the data model to the elements of the page to be presented at first-user interface 122 and render a visual representation on display 121 corresponding to data item 10. This visual representation may contain one or more data fields into which information, such as updates and/or revisions, may be entered relating to data item 10. When all information has been entered into the data fields in first-user interface 122, the first-user application called by system 100 may verify this information and update the database 110 with any changed values (see reference numeral 154).

In some embodiments, as shown in FIG. 1, a second-user transaction 160 may commence on data items in database 110, including data item 10. The second-user transaction 160 may take place at a time t₁, which may be after the start of first-user transaction 150 (e.g., t₀) but before first-user transaction 150 has committed. Accordingly, in embodiments involving snapshot isolation, the second-user transaction 160 would be unaware of the first-user transaction 150. That is, at the start of the second-user transaction 160, a snapshot of the database 110 as it exists at time t₁ (i.e., without any update yet by the first-user transaction 150 to data item 10) is provided at second-user interface 132. In some embodiments, the second-user transaction 160 may have instructions to also update or revise data item 10 based on instructions from the second-user interface 132 (e.g., a write operation) to update information associated with data item 10. Data item 10 may be retrieved from database 110 and read into internal buffer 162. The buffer 162 may be used to temporarily hold data item 10 while a data model is built for a page corresponding to data item 10 to be presented at the second-user interface 132. As with first-user transaction 150, system 100 may call a second-user application when the second-user transaction 160 is initiated to retrieve and/or read data item 10 into internal buffer 162 and build a data model for data item. Although FIG. 1 shows the buffer 162 separate from machine 134, buffer 162 may be located anywhere suitable. A second-user interface generator may then bind the data model to the elements of the page to be presented at second-user interface 132 and render a visual representation (e.g., one or more pages presented on user interface 122) on the display 131 that corresponds to data item 10. In some embodiments, the visual representation may be assembled and configured in accordance with a layout as defined by one or more user interface design patterns (i.e., a pattern-based user interface). The second user 130 may then enter information into the one or more data fields using any suitable input device 126, including without limitation, a keyboard or a mouse. When all information has been entered into the data fields on the second-user interface 132, the second-user application called by system 100 may verify this information and attempt update the database 110 with any changed values.

At this point in time, however, the second-user transaction 160 will not commit if the first-user transaction 150 has already committed and, in turn, updated or revised data item 10. Because each transaction (150, 160) proceeds in snapshot isolation and, thus, no locking is in place, the second-user transaction 160 will not realize that a concurrent operation by the first-user transaction 150 updating data item 10 has occurred. Under the snapshot isolation regime, the second-user transaction 160 is neither blocked by a lock, nor does it see the updates being provided by first-user transaction 150. However, once the second-user transaction 160 proceeds to operate upon data item 10 with conflicting information, the database 110 (or its associated DBMS) detects a conflict and reports this conflict to second-user machine 134.

Rather than call on an automated, programmatic mechanism (which may be part of an application associated with the second-user transaction 160) for resolving conflict between concurrent updates made in snapshot isolation, in some embodiments of the present disclosure, this task is pulled out of the second-user application and incorporated it into the system 100 as a generic protocol triggered by any concurrent data conflicts. More specifically, when a conflict is reported by the database 110 or system 100, the system 100 catches this event and starts a new transaction 190 without any special handling by any currently-executing application, e.g., the second-user application discussed above.

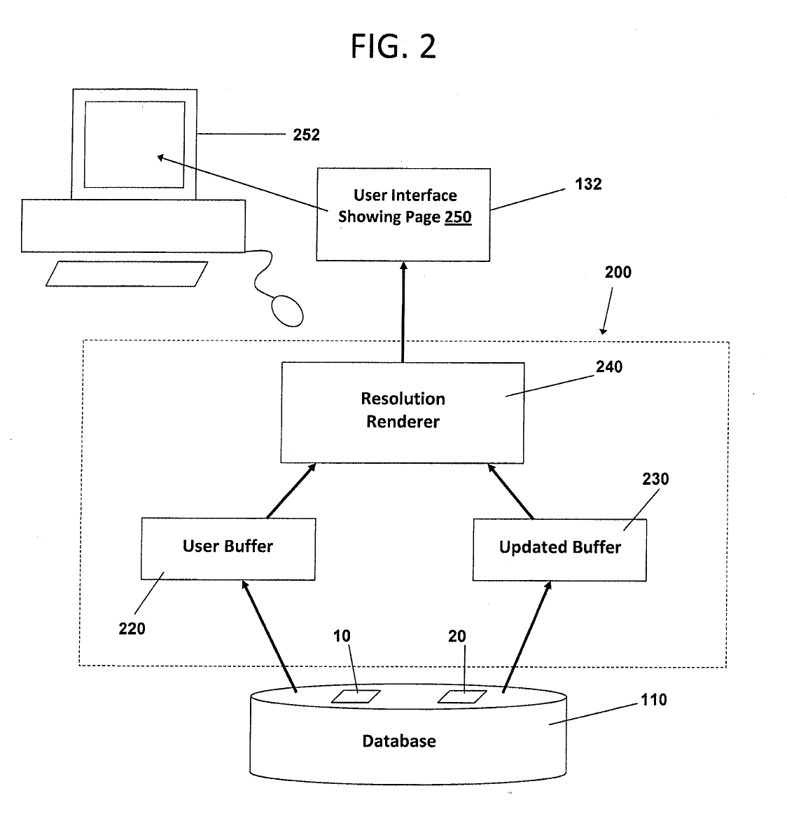

An example implementation of a conflict resolution system 200 and methodology associated with new transaction 190 is shown in FIG. 2. In some embodiments, new transaction 190 may get a new snapshot of the database 110, which includes an updated version of data item 10. This updated version is depicted as data item 20 in FIG. 2. Data item 20 reflects the change made by the first-user transaction 150. During the new transaction 190, data item 20 may be stored in updated buffer 230, also as shown in FIG. 2. The system 200 may then call a second-user application in exactly the same way as if the new transaction 190 were a completely different transaction, hiding the fact that the system 200 is in a conflict resolution mode. The called application may therefore perform the same usual steps (e.g., identify and retrieve a selected data item and build a data model), but now instead read the updated data, i.e., data item 20, from the first-user transaction 150 from the database 110 into the updated buffer 230 and build a data model for a new page 250 to be presented by second-user interface 132. The page 250 may be implemented as any type of electronic document including for example a hypertext markup language (HTML) page.

However, when the second-user interface generator binds the data model to the elements of the page 250 to render a visual representation on the user interface 132 corresponding to data item 10 originally selected by the second-user transaction 160, the conflict resolution system 200 injects a call to a generic resolution renderer component 240. In response, the resolution renderer 240 passes upon not only the data model for the second user's new transaction 190, but also the data model for the original (but stalled) second-user transaction 160, which may be temporarily stored in user buffer 220. The resolution renderer 240 may then be configured to compare the two data models, according to embodiments of the present disclosure, and identify the specific data fields that are in conflict.

With this information, the resolution renderer 240 may then be configured to dynamically extend the page 250 by duplicating all fields that are in conflict so that the input from the second-user transaction 160 regarding data item 10 is presented on the page 250 in a side-by-side orientation with the updated data (i.e., data item 20) created by the first-user transaction 150. The resolution renderer 240 may then render the page 250 as a dynamically-generated pattern user interface based on the data from the two data models for the second-user transaction 160 and new transaction 190.

As shown in FIG. 2, the original data item 10, before being updated by the first-user transaction 150, may be temporarily held in user buffer 220 and the updated version of this data, namely data item 20, may be temporarily held in updated buffer 230, for access by resolution renderer 240. In short, the resolution renderer 240 may be configured to retrieve both data items (10, 20) to create and display the page 250 on the second-user interface 132.

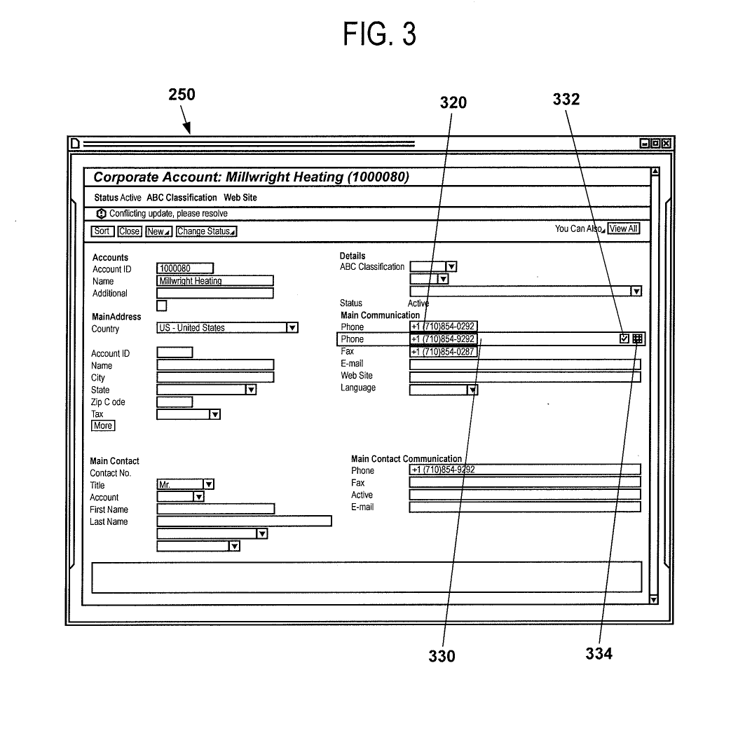

FIG. 3 shows an example implementation of page 250 generated by the resolution renderer 240 and presented at one of the user interfaces, such as the second-user interface 132 (and displayed by the second user's display 131). More specifically, the page 250 shown in FIG. 3 depicts an electronic form having multiple data fields. In some implementations, the data fields may contain information entered by the second-user transaction 160. Notably, the electronic form may contain one or more highlighted data fields 330. These fields 330 may contain the conflicting data entered by the first-user transaction 150. In the example in FIG. 3, the original input from second-user transaction 160 is shown in data field 320, directly above highlighted data field 330.

The highlighted data field 330 may also contain an “accept” button 332 and/or “reject” button 334, as shown in FIG. 3. The “accept” and “reject” buttons (332, 334) may be configured to allow selection at the user interface 132 (e.g., by an icon click by the second user 130) to resolve the conflict between the second user's original input from second-user transaction 160 and the data entered by the first user 120 via the first-user transaction 150. More specifically, if the second user 130 decides that the updated data is correct and should overwrite the second user's original data from the second-user transaction 160, the second user 130 may click the “accept” button 332. In response to this selection, resolution renderer 240 may copy the updated data from the data model of the new transaction 190 (contained in updated buffer 230) to the data model of the original second-user transaction 160 (contained in user buffer 220). In some embodiments, following the selection of “accept” and copying of the updated data, the second-user interface 250 may be refreshed to render a visual representation on display 252 that no longer shows highlighted data field 330, indicating that the resolution renderer 240 no longer detects a conflict as the values contained in the user buffer 220 and updated buffer 230 are the same. Accordingly, the data from field 330 will now be shown in field 320.

Conversely, the second user 130 may choose to reject the updated data because his or her original input from the second-user transaction 160 is correct and/or more up-to-date than the data provided by the first-user transaction 150. If so, the second user 130 may choose the “reject” button 334. In response to this selection, the resolution renderer 240 may copy the data from the data model of the second user's original transaction 160 (contained in user buffer 220) to the data model of the new transaction 190 (contained in updated buffer 230) to overwrite the updates provided by the first-user transaction 150. In some implementations, following the selection of “reject” and copying of the original data, the second-user interface 250 may be refreshed to render a visual representation on the display 252 that no longer shows highlighted data field 330, indicating that the resolution renderer 240 no longer detects a conflict as the values contained in the user buffer 220 and updated buffer 230 are the same. Accordingly, the original data from the data field 320 will remain and the updated data contained in field 330 will be removed.

Once the second user 130 has resolved all conflicts by either accepting or rejecting each one, both data models contained in the user buffer 220 and update buffer 230 will contain the same data. Accordingly, the new transaction 190 that was started as part of the conflict resolution protocol by system 200 may now be successfully committed to the database 110. At the same time, in some implementations, the system 200 may abort the second-user transaction 160 and discard the user buffer 220, as all data originally entered was copied to the now-committed new transaction 190 by the described approach of user-driven conflict resolution.

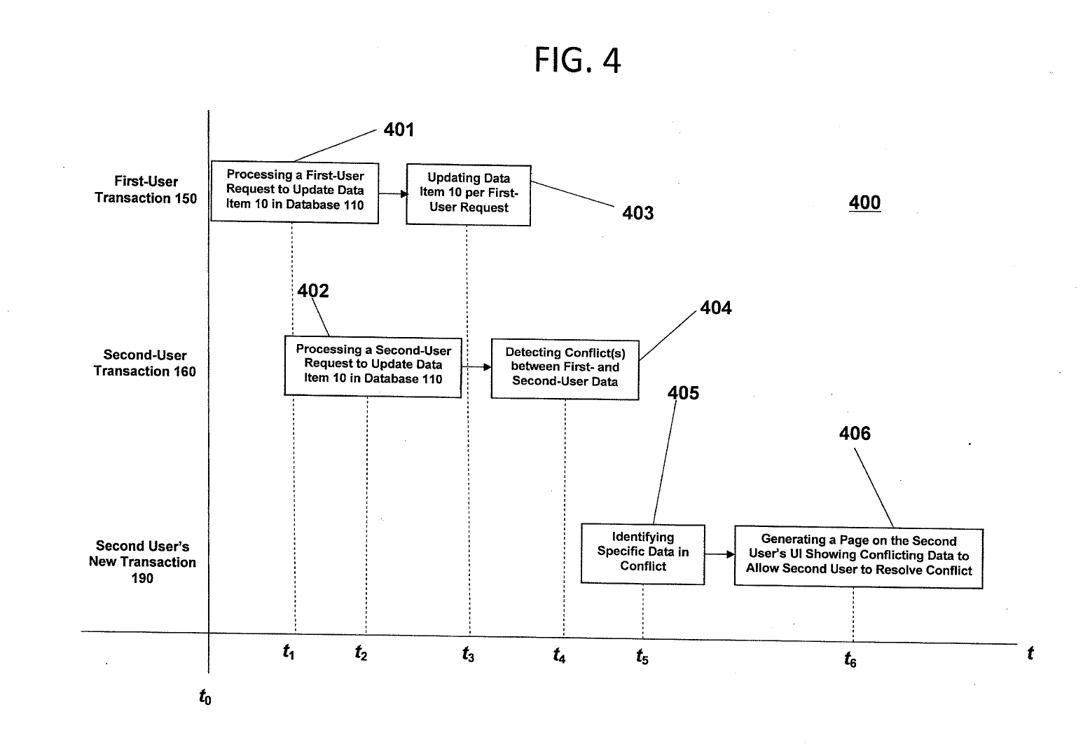

FIG. 4 shows a flow diagram depicting an example methodology 400 for user-driven conflict resolution in the context of the system 100 illustrated in FIG. 1. First-user transaction 150 is initiated at time t₀. At step 401, a first-user request to update data item 10 in database 110 with first user additional data is provided by the first-user interface 122 and processed by the first-user machine 124 in conjunction with database 110 and its corresponding DBMS. Second-user transaction 160 may be initiated at time t₁. At step 402, a second-user request to update one or more data items, including data item 10, in database 110 with second user additional data is provided by the second-user interface 132 and processed by the second-user machine 134 in conjunction with database 110 and its corresponding DBMS. At step 403, data item 10 may be updated with the first user additional data entered by the first-user transaction 150. At step 404, the system 100 may detect that at least a portion of the second user additional data is in conflict with at least a portion of the first user additional data. Upon detecting conflicting data, the system 100 may start a new transaction 190 for the second user, which identifies the specific data in conflict from each of the first user additional data and the second additional data, as shown at step 405. After the specific conflicts are identified, a conflict resolution system 200 takes control and injects a call to generic resolution renderer component 240 to generate a new page 250 displaying the specific data identified as conflicting (see FIG. 2). The conflict may then be reconciled at page 250, which is presented by second-user interface 132 by choosing which of the specific data in conflict from the first user additional data and second user additional is correct.

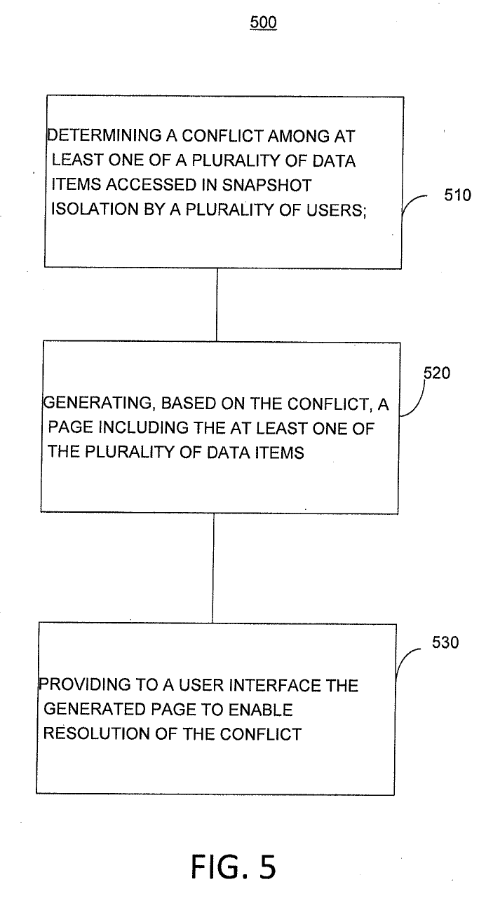

FIG. 5 shows another flow diagram depicting an example methodology 500 for user-driven conflict resolution. At 510, a conflict may be determined among at least one of a plurality of data items accessed in snapshot isolation by a plurality of users. At 520, a page may be generated based on the conflict. The page may include the at least one of the plurality of data items. At 530, the generated page may be provided to a user interface to enable resolution of the conflict.

Although the description refers to conflict resolution with the context of a database, other applications that process transactions may be used as well. Moreover, although the resolution renderer 240 is depicted at FIG. 2 at system 200, in some implementations, the resolution renderer 240 may be located in one or more other locations. For example, the resolution renderer 240 may include some aspects which are operative as a plug-in or an applet at a user interface, such as user interfaces 122 and 132. Furthermore, some implementations of the systems, methods, and articles described herein may be configured for use with one or more of the following: a pattern-based user interface created from one or more generic user interface components or building blocks; a data model representing the elements bound to the user interface controls, as in the standard Model-View-Controller pattern; and/or an application framework for mapping (e.g., object-relational mapping) from database tables to the data models associated with a user interface. As used herein, the term “user” may refer to one or more of a human, a machine, a processor, a user interface, and the like.

The subject matter described herein may be embodied in systems, apparatus, methods, and/or articles depending on the desired configuration. Embodiments of the subject matter described herein may be realized in digital electronic circuitry, integrated circuitry, specially designed application specific integrated circuits (ASICs), computer hardware, firmware, software and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device and at least one output device.

These computer programs, which may also be referred to as programs, software, software applications, applications, components or code, may include without limitation machine instructions for a programmable processor. Embodiments of these computer programs may be implemented in a high-level procedural and/or object-oriented programming language and/or in assembly/machine language. As used herein, the term “machine-readable medium” refers to any computer program product, apparatus and/or device, including but not limited to magnetic discs, optical disks, memory and Programmable Logic Devices (PLDs), used to provide machine instructions and/or data to a programmable processor, including without limitation a machine-readable medium that receives machine instructions as a machine-readable signal. The term “machine-readable signal” may refer to any signal used to provide machine instructions and/or data to a programmable processor. The machine-readable medium may store machine instructions non-transitorily, as would a non-transient solid state memory, magnetic hard drive or any equivalent storage medium. The machine-readable medium may alternatively or additionally store machine instructions in a transient manner, as would, for example, a processor cache or other random access memory associated with one or more physical processor cores.

Processors suitable for the execution of a computer program include, by way of example, both general and special purpose microprocessors and any one or more processors of any kind of digital computer. Generally, a processor will receive instructions and data from read-only memory (ROM), random access memory (RAM) or both. The essential elements of a computer are a processor for executing instructions and one or more memory devices for storing instructions and data. Generally, a computer will also include, or be operatively coupled to receive data from and/or transfer data to one or more mass storage devices for storing data, e.g., magnetic, magneto-optical disks or optical disks. Media suitable for embodying computer program instructions and data include all forms of volatile (e.g., RAM) or non-volatile memory, including by way of example only semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein may be implemented on a computer having a display device, such as for example a cathode ray tube (CRT) or a liquid crystal display (LCD) monitor for displaying information to the user. The computer may also have a keyboard and/or pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback or tactile feedback. Similarly, input from the user to the computer may be received in any form, including but not limited to visual, auditory or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user may interact with an implementation of the subject matter described herein, or any combination of such back-end, middleware, or front-end components. The components of the system may be interconnected by any form or medium of digital data communication, such as for example a communication network. Examples of communication networks include, but are not limited to, a local area network (“LAN”), a wide area network (“WAN”) and/or the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The embodiments set forth in the foregoing description do not represent all embodiments consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the embodiments described above may be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other embodiments may be within the scope of the appended claims.

What is claimed:

1. A computer program product, tangibly embodied in a non-transitory machine-readable medium, the computer program product containing instructions to configure a data processing apparatus to perform operations comprising:
determining a conflict among at least one of a plurality of data items accessed in snapshot isolation by a plurality of users;
generating, based on the conflict, a page including the at least one of the plurality of data items; and
providing to a user interface the generated page to enable resolution of the conflict.

2. The computer program product of claim 1, wherein the determining comprises programmatically initiating a new user request to update the at least one of the plurality of data items.

3. The computer program product of claim 1, wherein the conflict is determined by a generic resolution renderer configured to at least
compare first user data for updating the at least one of the plurality of data items and second user data for updating the at least one of the plurality of data items; and
identify specific data from the first user data and the second user data that is in conflict.

4. The computer program product of claim 3, wherein the generic resolution renderer is configured to at least dynamically extend the generated page by duplicating data fields relating to the specific data from the first user data and the second user data that is in conflict and displaying the specific data in conflict from the first user adjacent to the specific data in conflict from the second user.

5. The computer program product of claim 1, wherein the user interface displays specific data from a first user and a second user that is in conflict.

6. The computer program product of claim 5, wherein the user interface includes a selection element to allow a user to accept or reject which of the specific data from the first user and the second user is correct.

7. The computer program product of claim 1, wherein the operations comprise displaying the resolution of the conflict on the user interface.

8. A computer-implemented method comprising:
determining a conflict among at least one of a plurality of data items accessed in snapshot isolation by a plurality of users;
generating, based on the conflict, a page including the at least one of the plurality of data items; and
providing to a user interface the generated page to enable resolution of the conflict.

9. The computer-implemented method of claim 8, wherein the determining comprises programmatically initiating a new user request to update the at least one of the plurality of data items, and wherein at least one of the determining, the generating, and the providing are implemented on at least one processor.

10. The computer-implemented method of claim 8, wherein the conflict is determined by a generic resolution renderer configured to at least:
compare first user data for updating the at least one of the plurality of data items and second user data for updating the at least one of the plurality of data items; and
identify specific data from the first user data and the second user data that is in conflict.

11. The computer-implemented method of claim 10, wherein the generic resolution renderer is configured to at least dynamically extend the generated page by duplicating data fields relating to the specific data from the first user data and the second user data that is in conflict and displaying the specific data in conflict from the first user adjacent to the specific data in conflict from the second user.

12. The computer-implemented method of claim 8, wherein the user interface displays specific data from a first user and a second user that is in conflict.

13. The computer-implemented method of claim 12, wherein the user interface includes a selection element to allow a user to accept or reject which of the specific data from the first user and the second user is correct.

14. The computer-implemented method of claim 8, wherein the method comprises displaying the resolution of the conflict on the user interface.

15. A system comprising:
a processor; and
a memory, the processor and memory configured to perform a method comprising:
processing a first user request to update at least one of a plurality of data items in a database with first user additional data;
updating at least one of the at least one of a plurality of data items with the first user additional data in response to the first user request;
processing a second user request to update at least one of the at least one of a plurality of data items in the database with second user additional data;
determining that at least a portion of the second user additional data is in conflict with at least a portion of the first user additional data;
identifying specific data from each of the second user additional data and the first user additional data that is in conflict;
generating a page including the specific data identified as being in conflict; and
providing the generated page to enable resolution of the conflict at a user interface by choosing which of the specific data in conflict from the first user additional data and the second user additional data is correct.

16. The system of claim 15, the method comprising updating the at least one of a plurality of data items with the specific data chosen by the second user, wherein the first user request and the second user request are executed concurrently in snapshot isolation.

17. The system of claim 15, wherein determining that at least a portion of the second user additional data is in conflict with at least a portion of the first user additional data comprises automatically initiating a new request for the second user.

18. The system of claim 15, wherein a generic resolution renderer is configured to extend the user interface of the second user by duplicating data fields for the specific data that is in conflict and displaying the specific data that is in conflict from the second user additional data adjacent to the specific data that is in conflict from the first user additional data.

19. The system of claim 15, wherein the user interface of the second user displays a selection means that allows the second user to accept or reject the specific data in conflict from the first user additional data.

20. The system of claim 19, wherein upon the second user selecting to accept or reject the specific data in conflict from the first user additional data, the user interface of the second user is configured to indicate the second user's selection.
